(19) United States
(12) Patent Application Publication
(10) Pub. No.: US 2026/0148018 A1
(43) Pub. Date: May 28, 2026

(54) WEBTOON AUTOMATIC TRANSLATION SYSTEM AND METHOD USING IMAGE INFORMATION

(71) Applicant: Trulite Korea Co., Ltd., Seoul (KR)

(72) Inventors: Jungyoon Han, Seoul (KR); Hangyu Lee, Seoul (KR)

(21) Appl. No.: 18/963,662

(22) Filed: Nov. 28, 2024

(51) Int. Cl. G06F 40/47; G06V 10/44; G06V 20/30

(52) U.S. Cl. CPC G06F 40/47; G06V 10/44; G06V 20/30; G06V 2201/13

(57) ABSTRACT

Provided is a webtoon automatic translation system using image information including: a webtoon providing terminal that, while providing a webtoon file containing both text and images to an automatic translation server, selects the language to be translated and receives the translated webtoon after the translation is completed; and an automatic translation server that, after receiving the webtoon file, extracts meta-information describing the images—including characters—in each cut containing dialogues, specifies the speaker for each text using the extracted meta-information, and translates the text by reflecting the meta-information that explains the specified speaker.

### BACKGROUND OF THE INVENTION

### Field of the Invention

The present invention relates to a webtoon automatic translation system and method using image information. More specifically, it involves specifying the speaker of the text based on the images in each cut (panel) of the webtoon and generating meta-information that explains the identified speaker. By reflecting the meta-information that describes the specified speaker and the mood of the cut when automatically translating the text of each cut through a translation engine, it becomes possible to generate optimized translations that match the context understood by readers who read the text while viewing the images of the webtoon.

### Description of the Related Art

Recently, with the improved accessibility to webtoons via smartphones and the excellence in story and artwork, the size of the webtoon market has been expanding annually. However, the Korean webtoon market is still insignificant compared to foreign webtoon markets such as those in the United States and China.

As a result, various attempts have been increasing to advance works that have proven artistic merit and commercial success domestically into overseas markets. In particular, various systems and methods for translating webtoons have been introduced.

Generally, to translate the dialogues in a webtoon, professional personnel proficient in each country's language review the original webtoon and translate the dialogues in each image. This process often requires a long time and significant cost.

Accordingly, not only is it difficult for individual creators to have opportunities to present their webtoon works to global readers, but there is also the problem that it takes a long time to complete the translation due to the lack of translators or companies specializing in translating webtoon content.

In addition, recently, there are cases where texts are machine-translated using automatic translation engines such as Google Translate. However, since such machine translations translate only the text without considering the images presented in the webtoon, incorrect translations that were not intended in the context of the original work frequently occur.

Furthermore, while using automatic translation engines to translate webtoons can significantly reduce the time required for translation, there is a problem of degraded translation quality due to the limitations of automatic translation engines that translate based only on text without considering images. This results in translations that are far from the original intent, or the context and situations intended to be expressed in each image.

### SUMMARY OF THE INVENTION

The present invention aims to solve the aforementioned problems by providing a webtoon automatic translation system and method using image information. By identifying the speaker of the text based on the images of each panel composing the webtoon and generating meta-information that describes the specified speaker, the system reflects this meta-information—which includes the identified speaker and the mood of the panel—when automatically translating the text of each panel using a translation engine. This allows for the generation of optimized translations that align with the context perceived by readers who read the text while viewing the images of the webtoon.

The above and other objects and advantages of the present invention will become apparent from the following detailed description of preferred embodiments.

To achieve the above object, the webtoon automatic translation system and method using image information may include: a webtoon providing terminal that selects the language to be translated while providing a webtoon file containing both text and images to an automatic translation server, and receives the translated webtoon after the translation is completed; and an automatic translation server that, after receiving the webtoon file, extracts meta-information describing the images—including characters in each cut containing dialogue—specifies the speaker for each text using the extracted meta-information, and translates the text by reflecting the meta-information describing the specified speaker.

In this case, the automatic translation server may include: a vision information analysis unit that analyzes the webtoon file to extract the dialogues to be translated and images necessary for understanding the context of each cut, and generates meta-information describing the context of the corresponding cut by analyzing the extracted images; and a multilingual automatic translation unit that specifies the speaker of each text in the corresponding cut based on the meta-information and automatically translates the text using an LLM (Large Language Model) that reflects the meta-information describing the specified speaker.

Additionally, the vision information analysis unit may include: a reference cut setting unit that divides the multiple cuts constituting the webtoon into reference cuts where automatic translation can proceed and adopts the images in each reference cut as elements for understanding the context of the corresponding cut; a vision information extraction unit that analyzes the images included in the reference cut to specify characters and backgrounds for understanding the context, and extracts features that the reader can visually perceive from each character and background as vision information; and a meta-information labeling unit that labels the vision information explaining the features of each character and background identified in the reference cut to generate meta-information that describes the images of the reference cut in detail and stores it in a database.

Furthermore, the vision information extraction unit may determine the speaker included in the reference cut, background images, or sound effects depicted without speech bubbles as elements for understanding the context of the reference cut, and extract vision information that the reader can visually perceive when viewing each element.

The vision information extraction unit may extract the speaker's gender, age group, hairstyle, attire, posture, or the direction the face or hands are pointing—as identified from the speaker's image—as vision information to grasp the characteristics of the speaker.

Moreover, the vision information extraction unit may extract the place and historical background identified from the background image, the types of props, and the direction in which the props are pointing as vision information.

The vision information extraction unit may also extract sound effects depicted in the reference cut without speech bubbles as vision information indicating the overall mood of the reference cut.

The multilingual automatic translation unit may utilize an LLM (Large Language Model) or LMM (Large Multimodal Model) based on Llama (Large Language Model Meta AI), which is a language model capable of generating an optimized translation model by learning not only language but also images.

In another embodiment, the webtoon automatic translation method using image information may include: a webtoon file receiving step where the automatic translation server receives a webtoon file containing both text and images to be translated, transmitted from the webtoon providing terminal, and stores it in a database; a vision information analysis step where the webtoon file is analyzed to extract the dialogues to be translated and images necessary for understanding the context of each cut, and the extracted images are analyzed to generate meta-information describing the context of the corresponding cut; and a multilingual automatic translation step where, based on the meta-information, the speaker of each text in the corresponding cut is specified, and the text is automatically translated using an LLM (Large Language Model) that reflects the meta-information describing the specified speaker.

In the vision information analysis step: a reference cut setting step divides the multiple cuts constituting the webtoon into reference cuts where automatic translation can proceed, and adopts the images in each reference cut as elements for understanding the context of the corresponding cut; a vision information extraction step analyzes the images included in the reference cut to specify characters and backgrounds for understanding the context, and extracts features that the reader can visually perceive from each character and background as vision information; and a meta-information labeling step labels the vision information explaining the features of each character and background identified in the reference cut to generate meta-information that describes the images of the reference cut in detail and stores it in a database.

In the vision information extraction step: the speaker included in the reference cut, background images, or sound effects depicted without speech bubbles may be determined as elements for understanding the context of the reference cut, and vision information that the reader can visually perceive when viewing each element is extracted; the speaker's gender, age group, hairstyle, attire, posture, or the direction the face or hands are pointing—as identified from the speaker's image—may be extracted as vision information to grasp the characteristics of the speaker; the place and historical background identified from the background image, the types of props, and the direction in which the props are pointing may be extracted as vision information; and sound effects depicted in the reference cut without speech bubbles may be extracted as vision information indicating the overall mood of the reference cut.

In the multilingual automatic translation step: an LLM (Large Language Model) or LMM (Large Multimodal Model) based on Llama (Large Language Model Meta AI), which is a language model capable of generating an optimized translation model by learning not only language but also images, may be utilized.

According to embodiments of the present invention, by reflecting meta-information that describes the specified speaker and the mood of the cut when automatically translating the text in each cut of the webtoon using a translation engine, it is possible to generate optimized translations that align with the context perceived by readers who read the text while viewing the images of the webtoon.

In addition, the present invention can reduce the time and cost required for translation by automatically translating webtoon files using a multilingual translation engine without relying on professional translation personnel.

Furthermore, since translations that match the context understood from the images of the webtoon can be quickly generated by automatic translation, the present invention can increase translation requests from individual creators, thereby expanding opportunities for individual creators to enter overseas markets.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a block diagram of the webtoon automatic translation system using image information according to the present invention.

FIG. 2 is an overall flowchart of the webtoon automatic translation system using image information according to the present invention.

FIG. 3 is an exemplary diagram illustrating the extraction and learning of meta-information from webtoon images according to the present invention.

FIG. 4 is an exemplary diagram illustrating the automatic translation using meta-information in the automatic translation server according to the present invention.

FIG. 5 is an exemplary diagram illustrating the learning of a language translation model optimized for webtoons according to the present invention.

FIG. 6 is an exemplary diagram illustrating the learning of a language translation model that reflects the characteristics of the speaker appearing in images according to the present invention.

FIGS. 7 to 10 are exemplary diagrams showing an example of a webtoon file in which English translation is performed according to the present invention.

FIG. 11 is a block diagram of the webtoon automatic translation method using image information according to the present invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

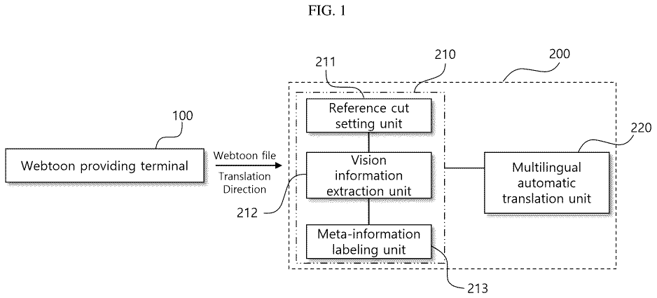

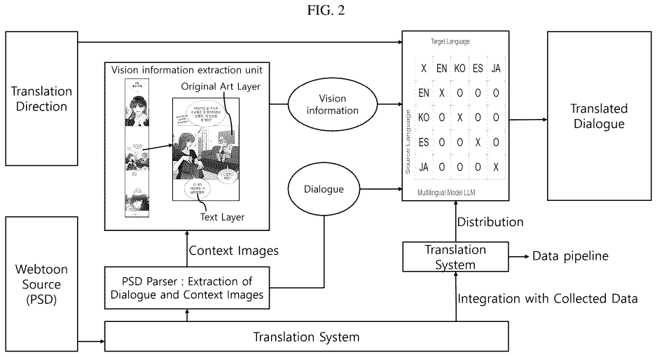

Hereinafter, the embodiments of the webtoon automatic translation system and method using image information according to the present invention will be described in detail with reference to FIGS. 1 to 6. FIG. 1 is a block diagram of the webtoon automatic translation system using image information according to the present invention, and FIG. 2 is an overall flowchart of the webtoon automatic translation system using image information according to the present invention.

Referring to FIGS. 1 and 2, the webtoon automatic translation system using image information according to the present invention may include: a webtoon providing terminal 100 that selects the language to be translated while providing a webtoon file containing both text and images to an automatic translation server, and receives the translated webtoon after the translation is completed; and an automatic translation server 200 that, after receiving the webtoon file, extracts meta-information describing the images—including characters in each cut containing dialogue—and specifies the speaker for each text using the extracted meta-information, and translates the text by reflecting the meta-information describing the specified speaker.

The webtoon providing terminal 100 is a terminal managed by an individual creator or webtoon-related person who wants to translate the text described in the webtoon into a foreign language. It can be configured as a terminal such as a personal computer or laptop equipped with communication means and input/output means capable of connecting to the automatic translation server 200 over a network to transmit the webtoon file and receive the translated webtoon in which the text content has been translated into a foreign language.

Accordingly, even as an individual creator who wants to present their work to the overseas market, they can request automatic translation using their own personal computer or laptop and receive the results, thereby having more opportunities to showcase their work to global readers in the overseas market.

Also, the automatic translation server 200 may include: a vision information analysis unit 210 that analyzes the webtoon file to extract the dialogues that need to be translated for each cut and the images necessary for understanding the context of the corresponding cut, and analyzes the extracted images to generate meta-information that describes the context of the corresponding cut; and a multilingual automatic translation unit 220 that specifies the speaker of each text in the corresponding cut based on the meta-information, and automatically translates the text using an LLM (Large Language Model) that reflects the meta-information describing the specified speaker.

The vision information analysis unit 210 may include: a reference cut setting unit 211 that divides the multiple cuts constituting the webtoon file into reference cuts where automatic translation can proceed, and adopts the images in each reference cut as elements for understanding the context of the corresponding cut; a vision information extraction unit 212 that analyzes the images included in the reference cut to specify characters and backgrounds for understanding the context, and extracts features that the reader can visually perceive from each character and background as vision information; and a meta-information labeling unit 213 that labels the vision information explaining the features of each character and background identified in the reference cut to generate meta-information that describes the images of the reference cut in detail and stores it in a database.

Generally, since webtoons are viewed with both text and images together, even if the text consists only of a short situational description or brief dialogue, readers can easily grasp the context in which the dialogue or explanation is used based on the accompanying images drawn with the text.

However, when machine translation is performed, only the text extracted from the webtoon file is subject to translation, making it impossible to grasp the situation or context in which the text is used.

Accordingly, the vision information analysis unit (210) generates meta-information that faithfully describes the images accompanying the text to be translated and transmits it to the multilingual automatic translation unit (220). This allows the content of the images—which are essential for understanding the context but are not the subject of translation—to be reflected in the text translation.

To achieve this, the reference cut setting unit (211) crops to include one image cut in the webtoon file and the speech bubbles spanning above and below that cut to set a single reference cut, and sets the images and texts included in the set reference cut as elements for understanding the context of the corresponding cut.

Generally, a cut in a webtoon is drawn to include dialogue and images within a rectangular frame, but it frequently occurs that speech bubbles containing dialogue extend beyond the frame. Therefore, the reference cut setting unit 211 can set the speech bubbles to be included in the reference cut toward which the direction of the speech bubble pointing to the speaker is oriented, in cases where there are speech bubbles above or below each cut.

By setting the boundary where the context that can be understood in a single cut is applied in the reference cut setting unit 211 as described above, it becomes possible to achieve translations where the context of the dialogues appearing in each cut is consistently applied.

Additionally, the vision information extraction unit 212 determines the speaker included in the reference cut, background images, or sound effects depicted without speech bubbles as elements for understanding the context of the reference cut and can extract vision information that the reader can visually perceive when viewing each element.

To achieve this, the vision information extraction unit 212 can analyze the PSD (Photoshop Document) file of the webtoon by accessing the accessing layer using a PSD parser capable of reading layer information of the webtoon file composed of PSD files. That is, the vision information extraction unit 212 can extract the vision information necessary for the translation work by analyzing the text layer of the PSD file.

Accordingly, in the vision information extraction unit 212, for the speaker, it is possible to extract as vision information the speaker's gender, age group, hairstyle, attire, posture, and the direction in which the face or hands are pointing, as identified from the image.

Also, in the vision information extraction unit 212, for the background, it is possible to extract as vision information the place and historical background identified from the image, the types of props, and the direction in which the props are pointing.

Moreover, in the vision information extraction unit 212, in cases such as sound effects that allow understanding the overall mood of the reference cut without speech bubbles, it is possible to extract these as vision information indicating the overall mood of the reference cut.

Additionally, the meta-information labeling unit 213 can generate meta-information for the reference cut by labeling the images of the reference cut using the vision information about the speaker and background extracted from the reference cut.

At this time, the meta-information labeling unit 213 can label the vision information for the reference cut as sentence-form meta-information generated based on natural language so that the meta-information for the reference cut can be learned in the multilingual automatic translation unit based on LLM (Large Language Model) capable of automatic translation considering context.

Furthermore, the meta-information labeling unit 213 may adopt the LLaVA (Large Language and Vision Assistant) architecture to improve the performance and accuracy of the description of images generated based on the vision information.

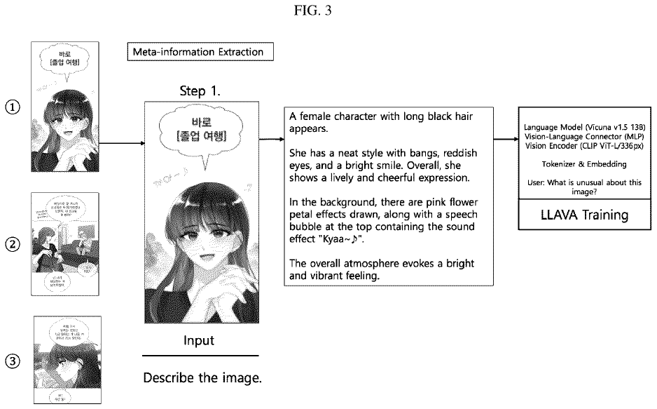

Accordingly, as shown in FIG. 3, it is possible to analyze the PSD file of the webtoon and set reference cuts that include speech bubbles and images as numbers \textcircled{1}, \textcircled{2}, and \textcircled{3}.

Then, in the vision information extraction unit 212, after receiving the first reference cut, reference cut \textcircled{1}, as input, it can specify a female character and sound effects without speech bubbles from the images shown in the reference cut, extract the hairstyle and facial expressions that represent the characteristics of the female character as vision information, and extract from the sound effects that the entire reference cut \textcircled{1} represents a cheerful mood as vision information.

Subsequently, in the meta-information labeling unit 213, it is possible to generate sentences describing reference cut \textcircled{1} according to the learned content based on the extracted vision information. As an example, shown in FIG. 3, it is possible to generate a sentence explaining the hairstyle and facial expression of the female speaker as meta-information for reference cut \textcircled{1}. Additionally, as additional meta-information for reference cut \textcircled{1}, it is possible to generate a sentence explaining that the speaker is speaking in an atmosphere that generally presents a bright and cheerful feeling due to pink petals and sound effects related to the speaker's surrounding background.

The meta-information shown in FIG. 3 is just one example of meta-information generated based on a model learned from images and text in numerous webtoon cuts, and of course, there may be some differences in the sentences generated as meta-information if the data used for learning is different.

Additionally, the multilingual automatic translation unit 220 may receive the original text for the reference cut to be translated and, after receiving the meta-information describing the images in the reference cut where the text is received, automatically translate the original text into the language selected by the translation requester using an LLM (Large Language Model) based on the speaker and the context of the reference cut identified by the meta-information.

Accordingly, as shown in FIG. 3, it is possible to receive the text extracted from the original webtoon file (i.e., the dialogue of characters appearing in each cut of the webtoon) along with the meta-information of the corresponding cut and execute automatic translation into the language selected by the translation requester.

In FIG. 3, it is indicated that the multilingual automatic translation unit 220 can translate mutually between English (EN), Korean (KO), Spanish(ES), and Japanese (JP), enabling multilingual translation.

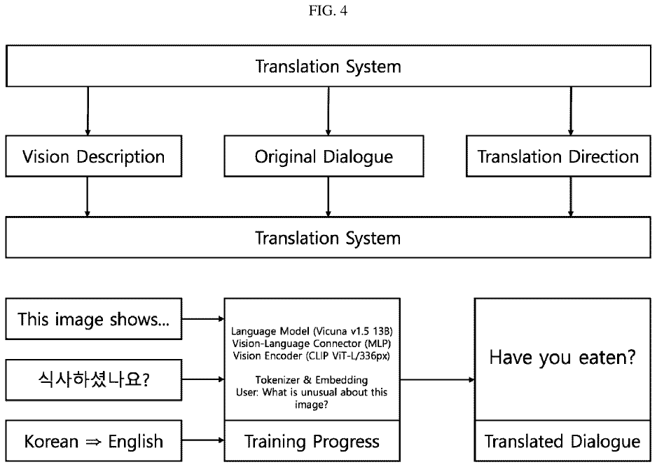

Therefore, as shown in FIG. 4, the multilingual automatic translation unit 220 receives the original text to be translated (shown as ‘Original Dialogue’), the meta-information describing the images in the corresponding reference cut (shown as ‘Vision Description’), and information about the translation direction (translating from Korean to English), and automatically translates the original text into the desired language using the translation model trained through reinforcement learning.

At this time, since the translated text reflects the meta-information about the images in the reference cut where the original text is located, it can be translated in a way that matches the context the author intended to express with the images.

Accordingly, in the multilingual automatic translation unit 220, as shown in FIG. 4, by using the meta-information describing the images in the reference cut (depicted as ‘This image shows . . . ’ in FIG. 4), the original text (depicted as ‘□□□□□□?’ in FIG. 4), and the translation direction (depicted as ‘Korean⇒ English’), it can be confirmed that ‘Have you eaten?’ is generated as the translated result for ‘□□□□□□?’ after training.

In other words, the multilingual automatic translation unit 220 can accurately specify the speaker and enable translation that matches the mood of the corresponding image by providing the meta-information that describes the images in the reference cut along with the original text to be translated.

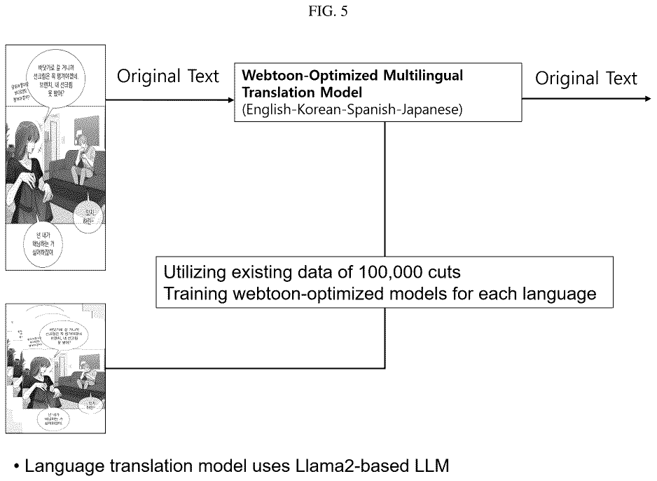

To achieve this, as shown in FIG. 5, the multilingual automatic translation unit 220 can learn from datasets of images and text in multiple webtoon cuts to generate translation models optimized for webtoons in each country's language. By inputting the original text of the webtoon to be translated into this webtoon-optimized translation model, it becomes possible to generate the translated text.

At this time, the multilingual automatic translation unit 220 may be configured to utilize an LLM (Large Language Model) or LMM (Large Multimodal Model) based on Llama (Large Language Model Meta AI), which is a language model capable of generating an optimized translation model by learning not only language but also images. In this webtoon-optimized multilingual translation model, mutual translation between English, Korean, Spanish, and Japanese can be configured.

Furthermore, the multilingual automatic translation unit 220 may be configured to generate the translated text by considering the characteristics of the speaker that can be identified from the images in the reference cut, which are extracted as meta-information from the vision information analysis unit.

Accordingly, as shown in FIG. 6, in the multilingual automatic translation unit 220, although the female speaker is talking to the male, the male speaker seems to avoid eye contact in the image, so it can grasp the context that the male speaker is responding with a cold attitude. By reflecting this, it can translate the male speaker's dialogue into a more formal language than the female speaker's dialogue, allowing the overall mood of the reference cut to be reflected in the translated text.

As such, by generating meta-information that describes the images of each cut constituting the webtoon in the vision information analysis unit 210, and automatically generating translated text that reflects the context identified based on this meta-information in the multilingual automatic translation unit 220, it becomes possible to quickly generate accurate translations that match the context the author intended to express with the images in the webtoon file.

That is, when the original text is input, the multilingual automatic translation unit 220 can generate a translated text that is appropriately translated for the webtoon to be translated by fine-tuning using the original text and meta-information in the multilingual translation model optimized for webtoons.

By translating the webtoon through automatic translation that requires less time and cost, while considering the meta-information about images that readers can visually perceive when viewing the webtoon, it becomes possible to derive optimized translations that match the speaker and mood.

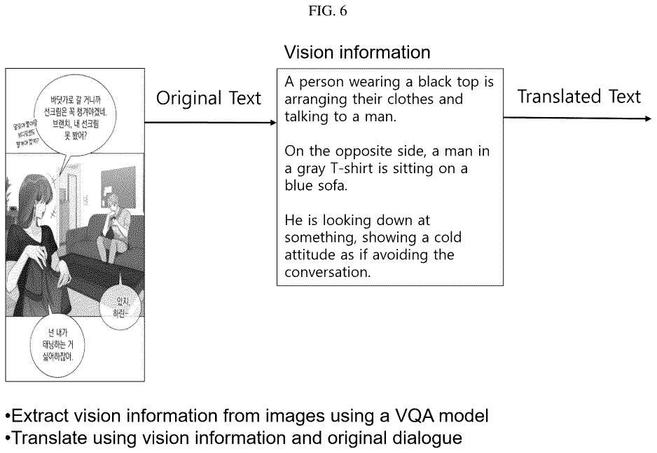

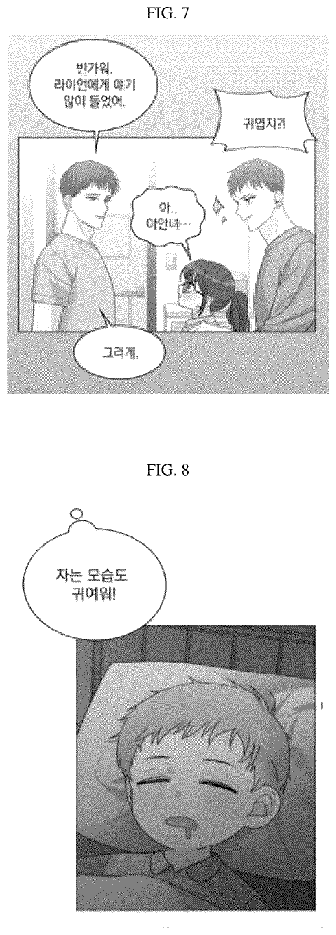

Next, an example of English translation using meta-information will be described with reference to the webtoon depicted in FIGS. 7 to 10. FIGS. 7 to 10 are exemplary diagrams showing an example of a webtoon file in which English translation is performed according to the present invention. First, in the example webtoon shown in FIG. 7, a reference cut with the following original text (dialogue) is automatically translated into English.

### Original Text (Dialogue)

□Man 1: □□□. □□□□□ □□ □□ □□□.

Man 2: □□□?

Woman 1: □. . □□□. .

Man 1: □□□. □

From the image shown in FIG. 7, it can be understood that ‘Man 1 and Woman 1 are having a conversation, and Man 2 is asking Man 1 whether a third person, Woman 1, is cute.’

However, when only looking at the text excluding the images, it is not clear who is saying ‘cute’ to whom. Therefore, if automatic translation is executed on the original text as is, it is common to get a translation like the ‘Translation without Image Context’ below.

### Translation Without Image Context

□Man 1: Nice to meet you! Ryan told me a lot about you.

Man 2: You're so cute, aren't you?

Woman 1: Oh . . . um, hi . . .

Man 1: I know, right? □

That is, an error occurs where the person whom Man 2 calls cute is Man 1, the next speaker in the dialogue, resulting in a translation that differs from the context of the image.

However, if the image-related information extracted by analyzing the images in the Vision Information Analysis Unit 210—that is, the meta-information that Man 2 is speaking to Man 1 while looking at Woman 1—is considered during translation, the Multilingual Automatic Translation Unit 220 can produce a translation like the “Translation with Image Context” below. Here, the person Man 2 calls cute is clearly Woman 1, not Man 1. Thus, even though it's an automatic translation, the context of the situation understood from the image is reflected, improving the accuracy of the translation.

### Translation With Image Context

□Man 1: Nice to meet you. I've heard a lot about you from Ryan.

Man 2: Isn't she cute?

Woman 1: H-hello . . .

Man 1: Indeed.□

Also, in the exemplary webtoon shown in FIG. 8, the reference cut containing the following original text (dialogue) is automatically translated into English.

### Original Text (Dialogue)

□□□ □□□ □□□! □

In FIG. 8, only a speech bubble expressing the thought of a third person observing a sleeping child is shown. Therefore, when translating, it should be expressed that the content is the thought of a third person who is looking at the sleeping child but does not appear in the image, to make a translation that matches the context.

Accordingly, if a professional translator translates FIG. 8 while looking at the webtoon image, it can be clearly expressed that it is the thought of a third person observing the child, as in the “Professional Translation” below.

### Professional Translation

□He's so cute even when he's asleep! □

However, if mechanical automatic translation is performed using the context understood from the text without considering the images, it may be translated as if the speaker is saying the line directly to the child appearing in the image, as in the “Machine Translation” below, resulting in a translation that somewhat deviates from the image.

### Machine Translation

□You're cute when you're sleeping too. □

In contrast, if the Vision Information Analysis Unit 210 analyzes the image and generates meta-information explaining that “the child is sleeping in bed, and the text is in a speech bubble representing the thought of a third person not appearing in the image,” the Multilingual Automatic Translation Unit 220 can perform automatic translation that matches the image. Considering that the speech bubble expressing the thought is that of a third person, as in the “Automatic Translation with Image Information” below.

### Automatic Translation With Image Information

□Even when sleeping, he's cute! □

Accordingly, when translating based only on text information, the listener is not considered. However, when image information is reflected even in automatic translation, it is possible to recognize that the text is the thought of a third person. Therefore, the speaker and context can be specified, allowing for an appropriate translation.

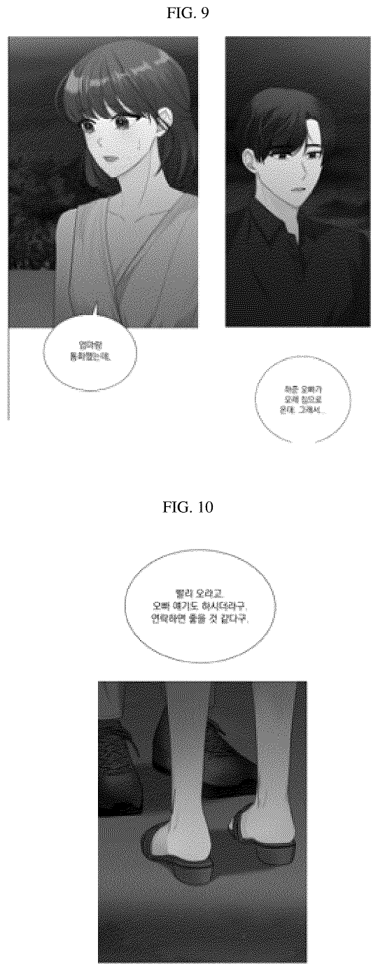

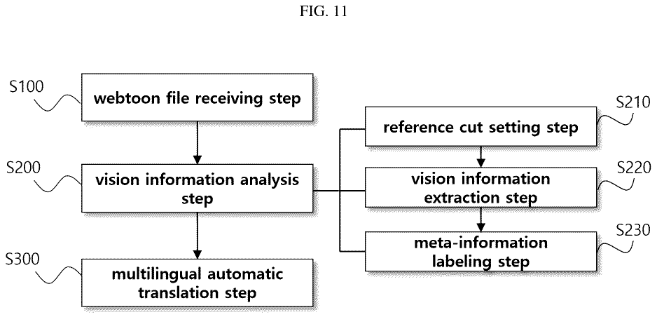

Also, in the exemplary webtoon shown in FIG. 10, the reference cut containing Dialogue 3 is automatically translated into English. However, since Dialogue 3 conveys someone else's words to the other person, the subject of whose words are being conveyed must be specified. It cannot be specified with only the cut shown in FIG. 10. Therefore, it is necessary to consider Dialogues 1 and 2 from the previous cut shown in FIG. 9 to achieve a translation that matches the context.

### Original Text (Dialogue)

□Dialogue 1: □□□ □□□□□,

Dialogue 2: □□ □□□ □□ □□□ □□. □□□. . .

Dialogue 3: □□ □□□. □□ □□□ □□□□□. □□□ □□ □□□. □

Accordingly, in professional translation that sequentially translates the content of FIG. 9 first and then FIG. 10, it is possible to understand that FIG. 10 is conveying the mother's words based on the context from the previous cut and translate as follows.

### Professional Translation

□She wanted me to come home. And she brought you up too, and said it would be nice if I could get in touch with you soon. □

In contrast, in machine translation that depends only on text for each cut, an error occurs where an unspecified pronoun is used as the subject, as it is not possible to specify whose words are being conveyed in the cut of FIG. 10.

### Machine Translation

□They want you to come back right away. They were asking about you too. Think you should give them a call. □

That is, in professional translation, “She” is used to accurately refer to the mother who appeared in the previous cut. In contrast, machine translation uses “They” without referring to the mother, causing an error where the reader of the translated webtoon has to figure out who “They” refers to.

However, if the Vision Information Analysis Unit 210 analyzes the images and identifies that the two leg images appearing in the cut of FIG. 10 are those of the two people appearing in the cut of FIG. 9, and understands that the subject of the conversation is the woman's dialogue continuing from FIG. 9, it can grasp the context that the woman is conveying the contents of a phone call with her mother.

Accordingly, the Multilingual Automatic Translation Unit 220 can, even while performing automatic translation, accurately translate the subject conveying the content of the call intended to be conveyed in FIG. 10 as “She” referring to the mother, just like in professional translation.

As described above, in the present invention, when translating the text in each cut of the webtoon, the speaker for each text is specified by analyzing the images accompanying the text. After understanding the background and mood inside the cut, this information is generated as meta-information about the image of the corresponding cut. By executing automatic translation, it becomes possible to generate translated texts that have contexts appropriate for the speaker's situation and the mood inside the cut.

Accordingly, by translating the webtoon through automatic translation without relying on professional translators, it is possible to reduce the time and cost required for translation while enabling appropriate and high-quality translation that matches the context understood by analyzing the images.

Next, with reference to FIG. 11, a detailed explanation of the webtoon automatic translation method using image information according to another embodiment of the present invention is provided. FIG. 11 is a block diagram of the webtoon automatic translation method using image information according to the present invention.

According to another embodiment of the present invention, the webtoon automatic translation method using image information may include: a webtoon file receiving step S100 where the automatic translation server receives a webtoon file containing both text and images to be translated, transmitted from the webtoon providing terminal, and stores it in a database; a vision information analysis step S200 where the webtoon file is analyzed to extract the dialogues that need to be translated for each cut and the images necessary for understanding the context of the corresponding cut, and the extracted images are analyzed to generate meta-information that describes the context of the corresponding cut; and a multilingual automatic translation step S300 where, based on the meta-information, the speaker of each text in the corresponding cut is specified, and the text is automatically translated using an LLM (Large Language Model) that reflects the meta-information describing the specified speaker.

In the vision information analysis step S200: a reference cut setting step S210 divides the multiple cuts constituting the webtoon into reference cuts where automatic translation can proceed, and adopts the images in each reference cut as elements for understanding the context of the corresponding cut; a vision information extraction step S220 analyzes the images included in the reference cut to specify characters and backgrounds for understanding the context, and extracts features that readers can visually perceive from each character and background as vision information; and a meta-information labeling step S230 labels the vision information explaining the features of each character and background identified in the reference cut to generate meta-information that describes the images of the reference cut in detail, and stores it in a database.

Since readers of webtoons view the text and images provided in cut units together, they can easily grasp the context of the text even if it consists only of brief dialogues without detailed situational explanations.

However, when machine translation is performed, only the text extracted from the webtoon file is subject to translation, making it impossible to grasp the situation or context in which the text is used, resulting in translations that deviate from the context of the images.

Accordingly, in the vision information analysis step S200, by generating meta-information that faithfully describes the images accompanying the text to be translated, it allows the content of the images—which are essential for understanding the context but are not the subject of translation—to be reflected in the text translation.

To achieve this, in the reference cut setting step (S210), one reference cut is set by cropping to include one image cut in the webtoon file and the speech bubbles spanning above and below that cut, and the images and texts included in the set reference cut are set as elements for understanding the context of the corresponding cut.

At this time, in cases where there are speech bubbles above or below each cut, the speech bubbles can be set to be included in the reference cut toward which the direction of the speech bubble pointing to the speaker is oriented.

By setting the boundary where the context that can be understood in a single cut is applied in the reference cut setting step S210 as described above, it becomes possible to achieve translations where the context of the dialogues appearing in each cut is consistently applied.

Also, in the vision information extraction step (S220), the speaker included in the reference cut, background images, or sound effects depicted without speech bubbles are determined as elements for understanding the context of the reference cut, and vision information that the reader can visually perceive when viewing each element is extracted.

To achieve this, in the vision information extraction step S220, the PSD (Photoshop Document) file of the webtoon can be analyzed by accessing the text layer using a PSD parser capable of reading layer information of the webtoon file composed of PSD files. That is, in the vision information extraction step S220, vision information necessary for the translation work can be extracted by analyzing the text layer of the PSD file.

Accordingly, in the vision information extraction step S220, for the speaker, it is possible to extract as vision information the speaker's gender, age group, hairstyle, attire, posture, and the direction in which the face or hands are pointing, as identified from the image.

Also, in the vision information extraction step S220, for the background, it is possible to extract as vision information the place and historical background identified from the image, props, and the direction in which the props are pointing.

Moreover, in the vision information extraction step S220, in cases such as sound effects that allow understanding the overall mood of the reference cut without speech bubbles, it is possible to extract these as vision information indicating the overall mood of the reference cut.

Furthermore, in the meta-information labeling step S230, the meta-information for the reference cut can be generated by labeling the images of the reference cut using the vision information about the speaker and background extracted from the reference cut.

At this time, in the meta-information labeling step S230, the vision information for the reference cut can be labeled as sentence-type meta-information generated based on natural language so that the meta-information for the reference cut can be learned in the multilingual automatic translation engine based on an LLM (Large Language Model) capable of automatic translation considering context.

Also, in the multilingual automatic translation step S300, the original text for the reference cut to be translated is received, the meta-information describing the images in the reference cut where the original text is received is received, and the original text is automatically translated into the language selected by the translation requester using an LLM (Large Language Model) based on the speaker and the context of the reference cut identified by the meta-information.

Accordingly, in the multilingual automatic translation step S300, the text extracted from the original webtoon file (i.e., the dialogue of characters appearing in each cut of the webtoon) is received along with the meta-information of the corresponding cut, and automatic translation into the language selected by the translation requester can be executed.

In the multilingual automatic translation step S300, mutual translation between English (EN), Korean (KO), Spanish(ES), and Japanese (JP) is possible, and by building a data pipeline, it can be configured to enable translation into other languages as well.

Since the translated text in the multilingual automatic translation step S300 reflects the meta-information about the images in the reference cut where the original text is located, it can be translated in a way that matches the context the author intended to express with the images.

That is, in the multilingual automatic translation step S300, by providing the meta-information describing the images in the reference cut along with the original text to be translated, it is possible to accurately specify the speaker and enable translation that matches the mood of the corresponding image.

To achieve this, in the multilingual automatic translation step S300, translation models optimized for webtoons in each country's language can be generated by learning from datasets of images and text in multiple webtoon cuts, and the translated text can be generated by inputting the original text of the webtoon to be translated into these webtoon-optimized translation models.

As such, in the multilingual automatic translation step S300, by generating the translated text considering the characteristics of the speaker in the reference cut obtained from the meta-information, it becomes possible to achieve more realistic and familiar translations for local readers.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims. The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A webtoon automatic translation system using image information, comprising:
a webtoon providing terminal that, while providing a webtoon file containing both text and images to an automatic translation server, selects the language to be translated and receives the translated webtoon after the translation is completed; and
an automatic translation server that, after receiving the webtoon file, extracts meta-information describing the images—including characters—in each cut containing dialogues, specifies the speaker for each text using the extracted meta-information, and translates the text by reflecting the meta-information that explains the specified speaker.

2. The webtoon automatic translation system using image information of claim 1, wherein the automatic translation server includes:
a vision information analysis unit that analyzes the webtoon file to extract dialogues that need to be translated in each cut and images necessary to understand the context of the corresponding cut, and analyzes the extracted images to generate meta-information that explains the context of the corresponding cut; and
a multilingual automatic translation unit that specifies the speaker of each text in the corresponding cut based on the meta-information and automatically translates the text using an LLM (Large Language Model) that reflects the meta-information explaining the specified speaker.

3. The webtoon automatic translation system using image information of claim 2, wherein the vision information analysis unit includes:
a reference cut setting unit that divides the multiple cuts constituting the webtoon file into reference cuts where automatic translation can proceed and adopts the images in each reference cut as elements for understanding the context of the corresponding cut;
a vision information extraction unit that analyzes the images included in the reference cut to specify characters and backgrounds for understanding the context and extracts features that readers can visually perceive from each character and background as vision information; and
a meta-information labeling unit that labels the vision information explaining the features of each character and background identified in the reference cut to generate meta-information that describes the images of the reference cut in detail and stores it in a database.

4. The webtoon automatic translation system using image information of claim 3, wherein the vision information extraction unit determines the speaker and background images included in the reference cut or sound effects depicted without speech bubbles as elements for understanding the context of the reference cut, and extracts vision information that readers can visually perceive when viewing each element.

5. The webtoon automatic translation system using image information of claim 3, wherein the vision information extraction unit extracts, as vision information for understanding the speaker's characteristics, the speaker's gender, age group, hairstyle, attire, posture, or the direction the face or hands are pointing, identified from the speaker's image.

6. The webtoon automatic translation system using image information of claim 3, wherein the vision information extraction unit extracts, as vision information, the location and historical background identified from the background image, types of props, and the direction the props are pointing.

7. The webtoon automatic translation system using image information of claim 3, wherein the vision information extraction unit extracts sound effects depicted in the reference cut without speech bubbles as vision information representing the overall mood of the reference cut.

8. The webtoon automatic translation system using image information of claim 2, wherein the multilingual automatic translation unit uses an LLM (Large Language Model) or LMM (Large Multimodal Model) based on Llama (Large Language Model Meta AI), which is a language model capable of generating an optimized translation model by learning not only language but also images.

9. A webtoon automatic translation method using image information, comprising:
a webtoon file receiving step where the automatic translation server receives a webtoon file containing both text and images to be translated, transmitted from the webtoon providing terminal, and stores it in a database;
a vision information analysis step where the webtoon file is analyzed to extract dialogues that need to be translated in each cut and images necessary to understand the context of the corresponding cut, and the extracted images are analyzed to generate meta-information that explains the context of the corresponding cut; and
a multilingual automatic translation step where, based on the meta-information, the speaker of each text in the corresponding cut is specified and the text is automatically translated using an LLM (Large Language Model) that reflects the meta-information explaining the specified speaker.

10. The webtoon automatic translation method using image information of claim 9, wherein in the vision information analysis step:
a reference cut setting step where the multiple cuts constituting the webtoon are divided into reference cuts where automatic translation can proceed, and the images in each reference cut are adopted as elements for understanding the context of the corresponding cut;
a vision information extraction step where the images included in the reference cut are analyzed to specify characters and backgrounds for understanding the context, and features that readers can visually perceive from each character and background are extracted as vision information; and
a meta-information labeling step where the vision information explaining the features of each character and background identified in the reference cut is labeled to generate meta-information that describes the images of the reference cut in detail and is stored in a database.

11. The webtoon automatic translation method using image information of claim 10, wherein in the vision information extraction step:
the speaker and background images included in the reference cut or sound effects depicted without speech bubbles are determined as elements for understanding the context of the reference cut, and vision information that readers can visually perceive when viewing each element is extracted.

12. The webtoon automatic translation method using image information of claim 10, wherein in the vision information extraction step:
the speaker's gender, age group, hairstyle, attire, posture, or the direction the face or hands are pointing, identified from the speaker's image, is extracted as vision information for understanding the speaker's characteristics.

13. The webtoon automatic translation method using image information of claim 10, wherein in the vision information extraction step:
the location and historical background identified from the background image, types of props, and the direction the props are pointing are extracted as vision information.

14. The webtoon automatic translation method using image information of claim 10, wherein in the vision information extraction step:
sound effects depicted in the reference cut without speech bubbles are extracted as vision information representing the overall mood of the reference cut.

15. The webtoon automatic translation method using image information of claim 9, wherein in the multilingual automatic translation step:
an LLM (Large Language Model) or LMM (Large Multimodal Model) based on Llama (Large Language Model Meta AI), which is a language model capable of generating an optimized translation model by learning not only language but also images, is used.
